(19) United States
(12) Patent Application Publication
(10) Pub. No.: US 2026/0122175 A1
(43) Pub. Date: Apr. 30, 2026

(54) METHOD AND SYSTEM FOR VOIP BASED PEER TO PEER (P2P) COMMUNICATION

(71) Applicant: WizRocket Inc., San Francisco, CA (US)

(72) Inventors: Ankur SAINI, Gurugram (IN); Sumantu Mittal, Noida (IN)

(73) Assignee: WizRocket Inc., San Francisco, CA (US)

(21) Appl. No.: 18/925,451

(22) Filed: Oct. 24, 2024

(51) Int. Cl. H04M 3/38; H04L 65/1053; H04L 65/1069; H04W 12/06

(52) U.S. Cl. CPC H04M 3/382; H04L 65/1053; H04L 65/1069; H04W 12/06

(57) ABSTRACT

A method implemented at a network node in a client-server architecture for signaling a called user. The method comprises authenticating a calling user and based thereupon receiving an authentication token from the calling user. A current network address of the calling user is tracked based upon receipt of the authentication token. A signaling stack such as web-socket is employed to signal a communication notification to the called user based on tracked network address. Thereafter, the communication notification is overlaid by the signaling stack with the multimedia content to indicate an intention behind the communication notification to the called user. Upon acceptance of the communication notification by the called user, the called user is connected with the calling user through a call manager stack.

### FIELD OF THE INVENTION

The embodiments discussed in the present disclosure are generally related to P2P communication. In particular, the embodiments discussed are related to internet-call based P2P communication.

### BACKGROUND OF THE INVENTION

Modern era of communication has seen significant advancements, particularly with the widespread adoption of mobile phones and the internet. Traditional methods of signalling and communication between users primarily involve making voice or video calls, sending text messages, or using instant messaging applications. However, these methods have their limitations, particularly in terms of the type and richness of the information that can be conveyed during the signalling phase of a call. Typically, when a user receives a call, they have no contextual information about the call's purpose until they answer it. This lack of context can lead to inefficiencies, wasted time, and missed opportunities for both personal and business communications.

The advent of mobile technology and the internet has led to the development of various communication platforms that incorporate text, images, and video. Despite these advancements, a gap remains in seamlessly integrating multimedia content and contextual information within the signalling process itself. Current systems typically establish a call and then exchange multimedia content, if at all, during the call or through separate channels like emails or messaging apps. This fragmented approach leads to inefficiencies and a disjointed user experience.

Existing systems often rely on basic telephony signalling protocols that are not designed to carry rich media or contextual information. For example, the Public Switched Telephone Network (PSTN) and conventional Voice over IP (VoIP) systems focus solely on establishing audio or video connections without the capability to transmit additional payloads such as images, videos, or contextual data. While some modern communication platforms have introduced features like caller ID and basic notifications, these enhancements still fall short of rendering richer, more informative signalling. Specifically, while these methods have proven effective for basic communication needs, they fall short of providing a rich, context-aware, and multifaceted communication experience.

Moreover, state of the art methods fail to convey the context or intent behind a call, leading to misunderstandings and inefficiencies. Users are often left to guess the purpose of an incoming call, which can be inconvenient and time-consuming. Current systems do not natively support the transmission of rich media (images, videos, GIFs) within the call signalling process. Multimedia content is usually shared separately, disrupting the flow of communication and engagement.

Existing web-based services like Amazon web-services (AWS) for notifications require user permissions, which can be revoked or denied, leading to missed critical communications. Additionally, these notifications are not integrated into the call process and serve a different communication purpose. Traditional notification systems can be slow and unreliable, especially for urgent communications. They often lack the capability to deliver notifications instantly and seamlessly within the call setup process.

The United States patent document US20060177025A1 discloses an integrated messaging system which includes a messaging communication server (MCS) coupled to multiple networks of different types, and an interface module coupling the mobile communication server to a first type of network, wherein the first type of network includes a groupware application and a directory service, wherein the MCS performs messaging of a second type, including storing and accessing information particular to the second type in the directory service and wherein the messaging of the second type is independent of the first type of network. However, the said patent document fails to convey the context of a call or delivering important notifications, multi-media content via a signalling process.

Another patent document EP2779059A1 discloses an observation platform for mediating a communication in which a first communication is parsed with a computer system according to a policy to determine metadata associated with the first communication, wherein the metadata comprises a first set of attributes and wherein the first communication is received at the computer system from a first communication device. The first set of attributes is compared to attributes of a plurality of communication devices associated with the observation platform, the comparing performed by the computing system. At least one recipient communication device is identified from the plurality of communication devices for the first communication based on the comparing, the identifying performed by the computing system. However, such platform fails to disclose the transmission of multi-media content via a signalling process.

The need for a more versatile and enriched communication method is evident, particularly in business and regulatory environments where conveying the context of a VOIP based call or delivering important notifications can enhance user experience and operational efficiency. Traditional methods also lack the capability to personalize communication, which is increasingly important in today's customer-centric landscape. The ability to customize VOIP call based call screens with branding elements through promotional media is not supported by existing systems.

### SUMMARY OF THE INVENTION

Embodiments of a method, a corresponding apparatus, and a corresponding system are disclosed that address at least some of the above challenges and issues.

The subject matter of the present disclosure refers a method implemented at a network node in a client-server architecture for signaling a called user. The method comprises authenticating a calling user and based thereupon receiving an authentication token from the calling user. A current network address of the calling user is tracked based upon receipt of the authentication token. A signaling stack such as web-socket is employed to signal a communication notification to the called user based on tracked network address. Thereafter, the communication notification is overlaid by the signaling stack with the multimedia content to indicate an intention behind the communication notification to the called user. Upon acceptance of the communication notification by the called user, the called user is connected with the calling user through a call manager stack.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

Further advantages of the invention will become apparent by reference to the detailed description of preferred embodiments when considered in conjunction with the drawings:

FIG. 1 illustrates a control flow according to an embodiment of the present disclosure;

FIG. 2 illustrates an example implementation according to an embodiment of the present disclosure;

FIG. 3 illustrates a method according to an embodiment of the present disclosure; and

FIG. 4 illustrates a distributed computing-system implementation according to an embodiment of the present disclosure.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

Certain terms and phrases have been used throughout the disclosure and will have the following meanings in the context of the ongoing disclosure.

A “network” may refer to a series of nodes or network elements that are interconnected via communication paths. In an example, the network may include any number of software and/or hardware elements coupled to each other to establish the communication paths and route data/traffic via the established communication paths. In accordance with the embodiments of the present disclosure, the network may include, but are not limited to, the Internet, a local area network (LAN), a wide area network (WAN), an Internet of things (IoT) network, and/or a wireless network. Further, in accordance with the embodiments of the present disclosure, the network may comprise, but is not limited to, copper transmission cables, optical transmission fibres, wireless transmission, routers, firewalls, switches, gateway computers, and/or edge servers.

A “device” may refer to an apparatus using electrical, mechanical, thermal, etc., power and having several parts, each with a definite function and together performing a particular task. In accordance with the embodiments of the present disclosure, a device may include, but is not limited to, one or more IOT devices. Further, one or more IOT devices may be related, but are not limited to, connected appliances, smart home security systems, autonomous farming equipment, wearable health monitors, smart factory equipment, wireless inventory trackers, ultra-high-speed wireless internet, biometric cybersecurity scanners, and shipping container and logistics tracking.

“On-premises” may refer to the software and technology located within the physical confines of a network. An on-premises device may include, but is not limited to, a device located within the physical confines of a network. In accordance with the embodiments of the present disclosure, the term “on-premises” may be used interchangeably with the terms “site,” “office,” or “floor.”

The term “device” in some embodiments, may be referred to as equipment or machine without departing from the scope of the ongoing description.

A “processor” may include a module that performs the methods described in accordance with the embodiments of the present disclosure. The module of the processor may be programmed into the integrated circuits of the processor, or loaded in memory, storage device, or network, or combinations thereof.

“Database” may refer to an organized collection of structured information, or data, typically stored electronically in a computer system.

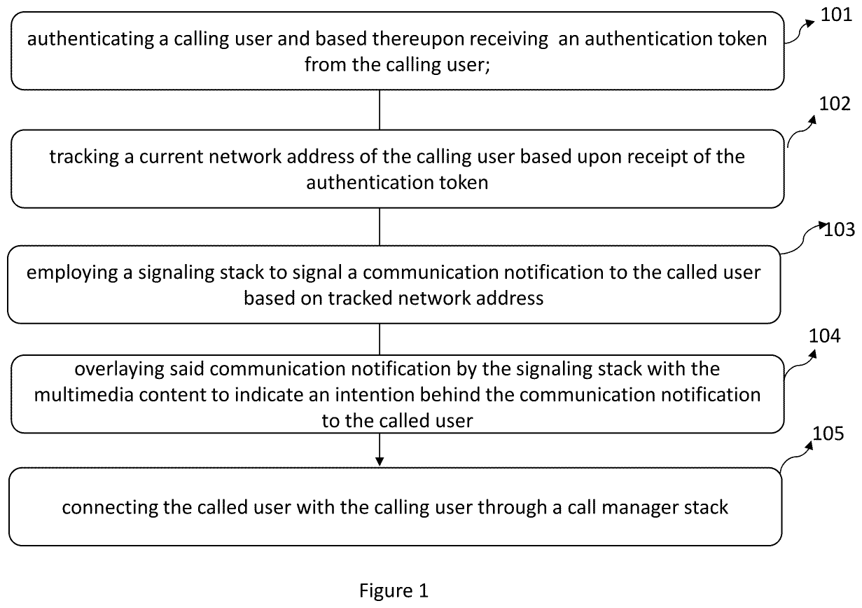

The embodiments of methods, apparatuses, and systems are described in more detail with reference to FIGS. 1-4.

FIG. 1 illustrates a method implemented at a network node in a client-server architecture for signaling a called user. The method comprises authenticating (step 101) a calling user and based thereupon receiving an authentication token from the calling user. For such purposes, an earlier received authenticating token from the called user is verified for authenticating the called user prior to tracking the network address of the calling user.

Further, a current network address of the calling user is tracked (step 102) based upon receipt of the authentication token. A signaling stack based on web socket signaling uses a caching/queuing system (as later discussed) to track the network address comprising a server address of the calling user for connecting with the called user.

Still further, the method comprises employing (step 103) the signaling stack to signal a communication notification to the called user based on tracked network address. Such employment of the signaling stack comprises using at least one of a web socket emit protocol or a push notification. In an implementation, the web socket emit protocol is configured to perform the steps of determining at least one of an intent and a call context of the calling user, and signaling the communication notification to the called user.

Further, the method comprises overlaying (step 104) the communication notification by the signaling stack with the multimedia content to indicate an intention behind the communication notification to the called user. The overlaying comprises displaying the rich media content within the communication notification at the device of the called user. The determination of intent by the signaling stack may be based on already cached data pertaining to the calling user or a real time input from the calling user. The overlaying the communication notification with rich media content comprising at least one of images, video, flash work etc based on the determined intent.

Further, the method comprises connecting (step 105) the called user with the calling user through a call manager stack, upon acceptance of the communication notification by the called user. The call manager stack connects with a caching system to allow access to the data of the called user and the calling user to enable a VOIP call connectivity between the called user and calling user. The Signaling Stack or web socket configured for signaling the Call Manager stack creates a channel by an operating system SDK of the device of the called user with the Call Manager stack to display a plurality of call controls comprising one or more of mute, disconnect/hang-up, and a plurality of controls associated with a call interface of a smartphone. Further, the call Manager Stack directs a state of the art VOIP call exchange, i.e. IP PBX (e.g. soft PBX) to open a single media or multimedia channel between the devices of the calling and the called user for voice flow as a part of the call.

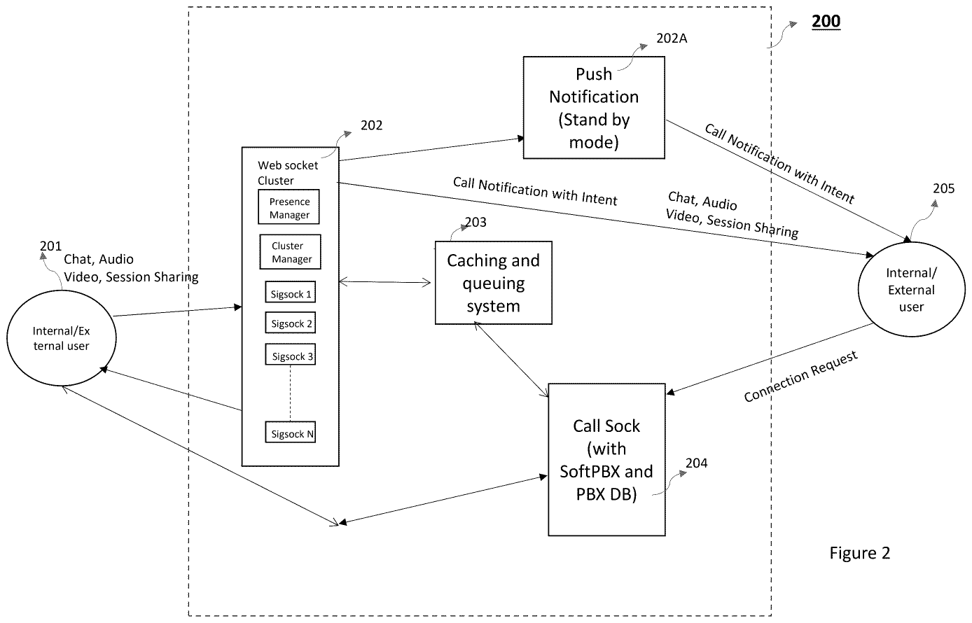

FIG. 2 illustrates an example implementation according to an embodiment of the present disclosure. Specifically, FIG. 2 illustrates an example of FIG. 1 with respect to the underlying control flow. The present subject matter relies on web-socket notifications powered by smartphone providers like Android and ioS (Google and Apple respectively).

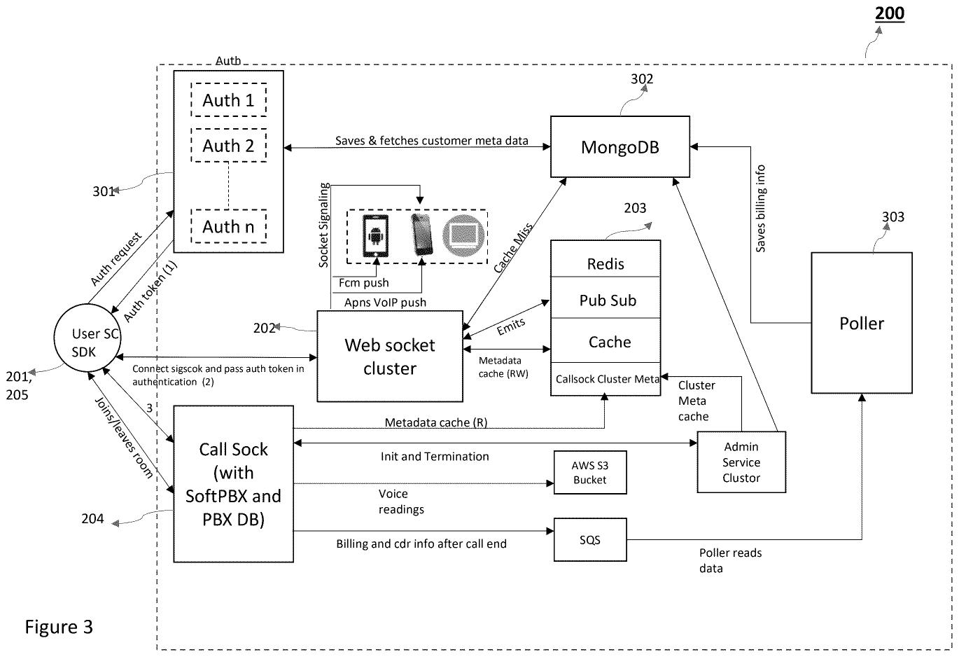

The web-socket module cluster 202 receives a call from a calling user 201 upon authentication. The authentication may be done by another entrusted node vide step 101 as also later referred in FIG. 3. The web-socket cluster 202 or the push notification service 202A (which operates upon failure of web-socket cluster 202 as a stand-by mode) executes the step 102 till 104. In parallel, a call manager stack 204 executes the step 105 of FIG. 1 and sends a call screen intimation annotated with rich text notification to the called user 205. A caching and queuing system 203 may be provided for facilitating the call and notification delivery to the called user from the calling user during the steps 102 till 105.

The web-socket module cluster 202 employs the web socket emit protocol to determine at least one of an intent and a call context of the calling user 201, signal the communication notification to the called user 205, and overlay the communication notification with rich media content comprising at least one of images, video, flash work etc based on the determined intent. Such determination of intent by the signaling stack 202 is based on cached data pertaining to the calling user 201 or a real time input from the calling user.

The overlaying refers displaying the rich media content within the communication notification at the device of the called user 205. Accordingly, the rich text notification vide the web-socket cluster 202 (or the push notification service 202A in standby) is availed vide smartphone operating system notification services APNS, FCM depending upon the type of operating system of the smartphone of an intended recipient. The web socket cluster 202 uses emits to signal, land, and receive multiple kinds of payloads including voice calls over IP (here's an example). Further, the call screen communicated as a part of call from call manager stack 204 can be altered to carry different payloads (e.g. phone call screen) annotated with rich media. The user devices 201, 205 comprise SDK's for all platforms, Android, iOS and Web.

FIG. 3 illustrates an network-implementation of the system 400 of FIG. 2 according to an embodiment of the present disclosure and thereby discusses various operations performed in line with method as illustrated in FIG. 1.

The present subject matter through signaling can transmit various payloads as opposed to any other system out there while establishing a connection between devices. Apart from communicating a payload to ring a phone device (which means can land an audio/video call), the present subject matter can also transmit rich media—images, GIF's and Video's on the call screens—for offers, important regulatory or urgent information. The present subject matter, alongside depicting the call's context at phone screen, additionally shows static full screen notifications for most urgent communication, without requiring a call-establishment between two parties.

In an example of payload, in case of a phone call communication requested by a calling party, a multimedia notification (GIF, flashwork, video) may be communicated as phone-screen as a part of phone-call. The notification may include branding-businesses own logo, brand colors on call-screens. It may also include context of a call (celebration, urgency, casual, business etc). The context of a call saves time and resources for both businesses and its consumers, since called user may or may not attend call and still be as much informed had the call been attended. Both the context of the call and/or branding may be communicated vide Rich Media such as Images (promotional or transactional like coupons with offers and add button for instant delight), GIF's for festivals and other engagement reasons (for winning something etc.), Video (for engagement and offers).

Yet other example of payload is a new age notification, which are delivered and rendered via sockets and do not require notification permission. These are for very specific and urgent use cases. These notifications may be also annotated with aforesaid branding, context and rich text media like the phone-call communication-based payload.

Referring to FIG. 3, the system 200 has been designed using web-sockets for faster and reliable communication. The system largely comprises following:
301—Authentication API
202—Signaling Stack or web socket cluster
203—Caching and queuing system
302—Database (MongodB)
204—Call Manager Stack
303—Poller

The Authentication API 301 is a server stack whose role is to authenticate and provide authentication tokens to the authenticated end user/client-side SDK's corresponding to the user devices 201, 205 to access the signaling stack 202. The API 301 registers the client-side device/SDK in the system.

The Signaling stack 202 or web socket cluster 202 is a server stack which is scalable and works as the signaling backbone for the entire system by executing steps 101 to 104 of FIG. 1. All end user devices 201, 205 connect with the Signaling Stack 202 post authentication. Signaling Stack 202 maintains information in a Caching and queuing System 203. End user devices 201, 205 could be upwards of 100Mn devices for a particular business and all those devices would be connected to a different Signaling server in the stack 202. Accordingly, when a call has to happen between two devices 201, 205 which are connected onto different Signaling servers, the Signaling Stack 202 uses the Caching System 203 to find out the location or network address of the signaling server associated with the connected devices 201, 205 and then signals the incoming call (in case of audio calls) or connects with the end user devices, and thereafter delivers the expected payload which in an example may be call notification or new age notification annotated with rich media.

The Caching and queuing system 203 provides a real time database to the Signaling Stack and the Call Manager Stack, thereby helping in lightning fast establishment of connections and delivery of various payloads. The caching and queuing system 203 may be based on “Redis Pub-Sub” that provides a framework for creating real-time chat features. Users can exchange messages instantly, making the chat experience seamless and engaging. “Redis” may render Geospatial Indexing, Rate Limiting for preventing API Abuse, Redis Cache in a Microservices Architecture, Redis Clustering for High Availability, Backend Systems etc. “Pub-Sub” refers publish-subscribe, which is a design pattern that enables publishers and subscribers to communicate with one another by sending and receiving messages through a message broker.

The database 302 or MongoDB at least serves two purposes, one is to keep the authentication data of a business mainly Key Value pair-Account id and API key and the other is to keep the CDR's (call data records) of the calls which have happened between devices 201, 205. The database 302 or the system 200 on the whole doesn't store any PII(personal identifiable information) data to make or receive calls. Accordingly, while the CDR's are purely kept for regulatory purposes for access by the users 201, 205 but at no point the system 200 knows the identity of the end user/s. In addition, a poller 303 keeps on accessing and updating the database 302 as a part of state-of-the-art polling operation.

The call manager stack 204 executes the step 105 of FIG. 1 and assists in displaying the call notification at the called user device 205. Further, once the called user 205 answers/picks up the call, the Signaling Stack 202 signals the Call Manager Stack 204 to engage, the SDK creates a channel with the socket of the Call Manager Stack 204, where call events like mute, disconnect/hangup, Bluetooth option and, and a plurality of controls associated with a call interface of a smartphone are communicated. The Call Manager Stack 204 in turn directs an IP PBX to open a voice/audio channel with the end user devices 201, 205 and voice flows or the audio call happens. Further, the SDKs at user devices 201, 205 negotiate a Voice channel port with the IP PBX during the call establishment between the user devices 201, 205. The user devices 201, 205 have an off the shelf CODEC and socket connection open with the Signaling Stack 202 and the Call Manager Stack 204 for management of the phone call and the audio channel.

Further, the call manager cluster 204 and the caching/queuing system 203 may interact with state of the art “admin service cluster” while accessing network resources and data. The call stack cluster 204 may also interact with simple Storage Service (S3) which provides object storage through a web service interface, and with Service (SQS) to avail message queuing service to send, store and retrieve multiple messages of various sizes asynchronously.

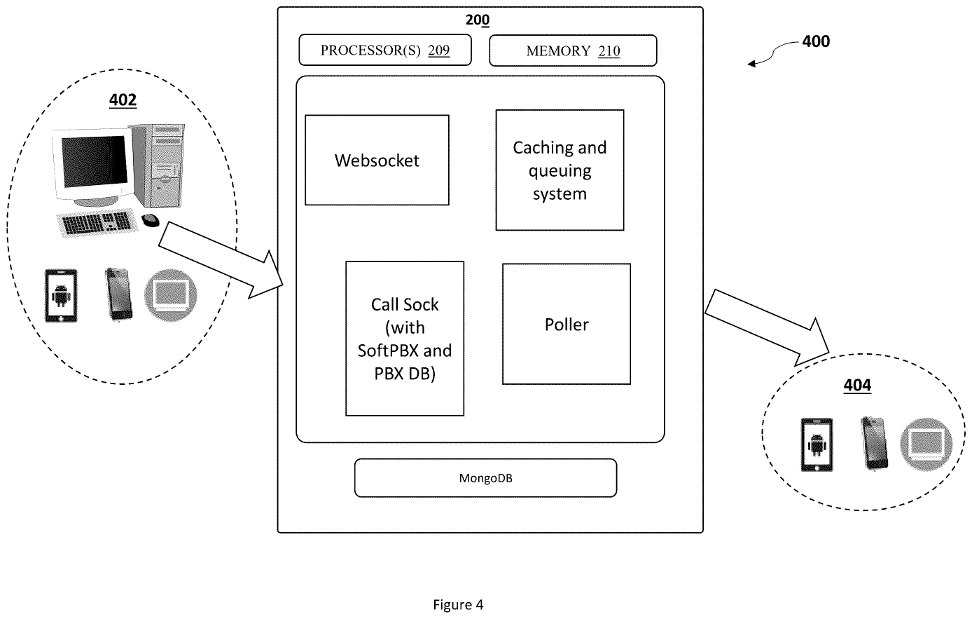

FIG. 4 illustrates a distributed computing-system 400 implementation of FIG. 3 according to an embodiment of the present disclosure. Each of the network nodes 201, 205 and 200 of the networking environments in FIG. 3 may be a stand-alone computing system 400. For sake of brevity, following description refers computing system 400 implementation only for system 200, although the same may apply for devices 201 and 205 as well.

The system 400 may essentially comprises one or more processors 209 that in turn may include different modules that are equivalent to the modules performing steps 101 to 105 in FIG. 1 and are therefore not explained here for the sake of brevity. The system 200 may be part of a larger computer system and/or maybe operatively coupled to a computer network (a “network”) with the aid of a communication interface to facilitate the transmission of and sharing data and predictive results. The computer network may be a local area network, an intranet and/or extranet, an intranet and/or extranet that is in communication with the Internet, or the Internet. The computer network in some cases is a telecommunication and/or a data network, and may include one or more computer servers. The computer network, in some cases with the aid of a computer system, may implement a peer-to-peer network, which may enable devices coupled to the computer system to behave as a client or a server.

The system 400 may also include memory 210 or memory locations (e.g., random-access memory, read-only memory, flash memory), electronic storage units (e.g., hard disks) communication interfaces (e.g., network adapters) for communicating with one or more other systems, and peripheral devices, such as cache, other memory, data storage, and/or electronic display adapters.

The one or more processors e.g., a CPU, execute a sequence of machine-readable instructions, which are embodied in a program (or software). The instructions are stored in a memory location. The instructions are directed to the CPU, which subsequently program or otherwise configure the CPU to implement the methods of the present disclosure. Examples of operations performed by the CPU include fetch, decode, execute, and write back. The CPU may be part of a circuit, such as an integrated circuit. One or more other components of the system may be included in the circuit. In some cases, the circuit is an application-specific integrated circuit (ASIC).

The system 400 also comprises one or more IO Managers as software instructions that may run on the one or more processors and implement various communication protocols such as User Datagram Protocol (UDP), Modbus, MQ Telemetry Transport (MQTT), Open Platform Communications Unified Architecture (OPC UA), Semiconductor's equipment interface protocol for equipment-to-host data communications (SECS/GEM), Profinet, or any other protocol, to access data in real-time from disparate data sources via any communication network, such as Ethernet, Wi-Fi, Universal Serial Bus (USB), Zigbee, Cellular or 5G connectivity, etc., or indirectly through a device's primary controller, through a Programmable Logic Controller (PLC) or through a Data Acquisition System (DAQ), or any other such mechanism.

In an embodiment, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

The present subject matter operates on web sockets and uses emits to signal, land, and receive multiple kinds of payloads including voice calls over IP (example). This allows an enhanced security layer on top of websocket. The call screens can be altered to carry different payloads annotated with rich media.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

1. A method implemented at a network node (200, 201, 205) in a client-server architecture for signaling a called user, the method comprising:
authenticating (step 101) a calling user (202) and based thereupon receiving an authentication token from the calling user (202);
tracking (step 102) a current network address of the calling user (202) based upon receipt of the authentication token;
employing (step 103) a signaling stack (202) to signal a communication notification to the called user (205) based on tracked network address,
overlaying (step 104) said communication notification by the signaling stack (202) with the multimedia content to indicate an intention behind the communication notification to the called user (205); and
upon acceptance of the communication notification by the called user (205), connecting (step 105) the called user (205) with the calling user (201) through a call manager stack (204).

2. The method as claimed in claim 1, further comprising verifying an earlier received authenticating token from the called user for authenticating the called user prior to tracking the network address of the calling user.

3. The method as claimed in claim 1, wherein employing the signaling stack (202) comprises using at least one of a web socket emit protocol or a push notification.

4. The method as claimed in claim 3, wherein the web socket emit protocol is configured to perform the steps of:
a) Determine at least one of an intent and a call context of the calling user;
b) Signal the communication notification to the called user; and
c) Overlay the communication notification with rich media content comprising at least one of images, video, flash work based on the determined intent.

5. The method as claimed in claim 4, wherein the overlaying comprises displaying the rich media content within the communication notification at the device of the called user.

6. The method as claimed in claim 4, wherein determination of intent by the signaling stack (202) is based on cached data pertaining to the calling user or a real time input from the calling user.

7. The method as claimed in claim 4, wherein the signaling Stack (202) uses a caching system (203) to track the network address comprising a server address of the calling user for connecting with the called user.

8. The method as claimed in claim 1, further comprising:
Connecting the call manager stack (204) with a caching system (203) to allow access to the data of the called user and the calling user to enable a call connectivity between the called user and calling user.

9. The method as claimed in claim 1, wherein the Signaling Stack (202) configured for signaling the Call Manager stack (204) performs the step of:
Creating a channel by an operating system SDK of the device of the called user with the Call Manager stack (204) to display a plurality of call controls comprising one or more of mute, disconnect/hang-up, and a plurality of controls associated with a call interface of a smartphone.

10. The method as claimed in claim 1, wherein the Call Manager Stack (204) directs an IP PBX to open a single media or multimedia channel between the devices of the calling (201) and the called user (205) for voice flow as a part of the call.

11. A system (400) implemented at a network node (200) in a client-server architecture for signaling a called user, the system configured to perform the steps of:
authenticating (step 101) a calling user (201) and based thereupon receiving an authentication token from the calling user;
tracking (step 102) a current network address of the calling user (201) based upon receipt of the authentication token;
employing (step 103) a signaling stack (202) to signal a communication notification to the called user (205) based on tracked network address,
overlaying (step 104) said communication notification by the signaling stack (202) with the multimedia content to indicate an intention behind the communication notification to the called user (205); and
upon acceptance of the communication notification by the called user (205), connecting (step 105) the called user with the calling user through a call manager stack (204).
